(19) United States
(12) Patent Application Publication
(10) Pub. No.: US 2002/0085185 A1
(43) Pub. Date: Jul. 4, 2002

(54) Method and system of varying optical imaging performance in the presence of refractive index variations

(75) Inventors: June L. Helmus, New Milford, CT (US); Andrew W. McCullough, Newtown, CT (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Silicon Valley Group, Inc.

(21) Appl. No.: 09/986,106

(22) Filed: Nov. 7, 2001

Related U.S. Application Data
(60) Provisional application No. 60/246,065, filed on Nov. 7, 2000.

(51) Int. Cl. G03B 27/52

(52) U.S. Cl. 355/30; 355/67; 355/53; 355/77

(57) ABSTRACT

The present invention provides a method and system for controlling the refractive index of gaseous mixture of the projection optics of a lithographic tool. In one embodiment, the present invention corrects projection optic aberrations due to altitude specific barometric pressure variations. Furthermore, the present invention provides control over the aberrations of an optical system, the ability to compensate for altitude changes, the ability to compensate for pressure changes, and the ability to purge gases from the optical system. In an embodiment, the system of the present invention includes at least one gas supply to provide a gas for a mixture, at least one mass flow controller associated with each gas supply, where the mass flow controller measures and controls the quantity of a respective gas for the mixture, and at least one flow gauge to substantially maintain laminar flow within the lithography apparatus. According to another embodiment of the present invention, the system further includes at least one filter to purify each gas for each gas supply, and at least one temperature control unit to maintain the temperature of the mixture at predetermined thermal specifications.

### CROSS-REFERENCE TO RELATED APPLICATIONS

This application claims the benefit of U.S. Provisional Application No. 60/246,065, “Method and System for Correcting Optic Aberrations Due to Altitude Specific Barometric Pressure Variations,” filed Nov. 7, 2000 (Atty. Docket No. 1857.0490000), which is incorporated by reference herein in its entirety.

### BACKGROUND OF THE INVENTION

1. Field of the Invention

The present invention pertains to optics, and in particular, to optics in microlithography.

2. Related Art

Photolithographic tools are extensively used in the semiconductor industry. See, Nonogaki et al., Microlithography Fundamentals in Semiconductor Devices and Fabrication Technology (Marcel Dekker, Inc.: New York, N.Y. 1998), incorporated by reference herein in its entirety.

A photolithographic printing tool includes a light source, reticle, optical system, and a wafer alignment stage. The light from the source illuminates the reticle, also called a mask, passes through the optical system to produce an image of the mask on a photoresist coated substrate to generate an image of the particular reticle pattern. The optical system is often a reduction system. The system may be a stepper or a scanning system. For example, ASM Lithography (ASML, formerly Silicon Valley Group), has introduced a number of ultra-violet exposure systems with catadioptric types of optical reduction systems and step-and-scan reticle/wafer stage systems. The patterned wafer is then further processed in various steps which result in the wafer containing a number of semiconductor devices.

Integrated circuit designs are becoming increasingly complex. The number of components and integration density of components in layouts is increasing. Demand for an ever-decreasing minimum feature size is high. This minimum feature size (also referred to in terms of linewidth) refers to the smallest dimension of a semiconductor feature that can be fabricated within acceptable tolerances. As a result, it is increasingly important that photolithographic systems and techniques provide higher resolution.

One approach to improve resolution is to decrease the wavelength of light used in fabrication. Another is to increase the numerical aperture (NA). Indeed, commercial exposure systems are being produced with decreasing wavelengths of light and increasing NA. For example, SVGL has introduced a number of ultra-violet exposure systems with catadioptric types of optical reduction systems and step-and-scan reticle/wafer stage systems. See, e.g., Nonogaki, at section 2.5.5, pp. 20-24. These UV exposure systems have light sources operating at a wavelength of 248 nanometers (nm) with an associated NA of 0.5 or 0.6, and at a wavelength of 193 nm with an associated NA of 0.5, 0.6, or 0.75. However, the next step in this procession, light at wavelengths equal to or less than 170 nm, and for example at 157 nm, have only recently been made feasible in photolithographic applications for semiconductor fabrication. A numeric aperture greater than 0.6, and for example at 0.75, has also only recently been made feasible at this range of wavelengths.

If the refractive index of the gas used to fill the projection optic component changes, then aberrations will be introduced and the lens performance will be affected. A prime example is of such an aberration is field curvature. This change may occur due to pressure changes: for example, in the long term, such as an altitude change of machine's site, and in the short term, such as due to changes in local weather conditions.

At shorter wavelengths, the changes in the index of refraction (n) from optic device to medium produce optic aberrations that alter the effective resolution of exposure systems. These aberrations can be reduced by source wavelength tuning which can roughly compensate for the changes encountered by balancing the imparted lens aberrations from index change with those induced by the wavelength shift of the source allowing for operation within normal exposure system parameters. These techniques are, however, less effective at higher NA and lower wavelength. In particular the 157 nm laser source has an intrinsically narrow bandwidth and this option is of less use.

Existing techniques to compensate for the optical aberrations are limited to laser source tuning applications that utilize 248 nm and 193 nm wavelengths. This is because the tuning range of the existing techniques does not provide sufficient compensation to be of any use at equal to or less than 170 nm, and for example at 157 nm. What is needed is a technique applicable at many wavelengths, including those described herein.

Index of refraction variations in the beam path have negative impacts on laser interferometer measuring systems. If gas leaks from the projection optic component, then it may cause changes in the gas composition in the interferometer path will result in changes in the index of refraction in the path and cause position error. This will impact the performance of the lithography system. What is needed is an index varying system utilizing two or more different gases that is capable of compensating for gas leaks by altering the gas composition within the projection optic component.

### SUMMARY OF THE INVENTION

The present invention provides an index varying system that meets the above-stated needs. Furthermore, the present invention is an index varying system that provides a means to maintain low projection lens aberrations. These aberrations can be imparted by but are not limited to altitude, temperature, pressure and weather variations. The inventors of the present invention identified a need to compensate for optical aberrations occurring as a result of elevation at which the lithography system was operated.

The appropriate choice of gas mixtures, which can be selected from the non-absorbing gas families, the application of the gas mixtures to correct for optic aberrations and/or different wavelengths. The refractive index of the gases used depends directly on the atomic weight.

In one embodiment, with the appropriate choice of gas mixtures, the refractive index of the gas can be maintained at the desired value for the wavelength in question while maintaining the refractive index at 638 nm (close to that of air).

In an embodiment of the present invention, an index varying system is provided that can reduce to near 2%, the error bar percentages at ultraviolet wavelengths equal to or less than 170 nm, and for example at 157 nm. Thus, the present invention is an index varying system that can alter the index of refraction inside the projection lens to simulate its behavior at any given altitude to effectively correct for image degradation due to barometric pressure variations.

The index varying system accounts for the differences in the index of refraction and provides a differing density of gas mixture to compensate.

The index varying system can reduce the optic aberrations and image degradation issues by providing a selectable and uniform altitude environment for the exposure system. The index varying system can accommodate sea-level conditions. In different embodiments, the index varying system can accommodate altitude conditions higher or lower than sea-level.

The index varying system can alternatively be used to compensate for wavelength differences. As an example, gas leakage from one location to another can cause index variations. This manifests itself into positioning errors if the index change occurs in an interferometer path. The system can employ wavelength diagnostics. For example, lithographic system characterization can be measured at an alternative wavelength than that specified in order to validate modeled performance.

Additionally, different gas mixtures can occupy various areas of a projection lens thus providing aberration fine tuning capability.

In one embodiment, an index varying system comprises a supply of gases, such as Helium and/or Nitrogen; optionally, at least one filter to purify the gases; at least one mass flow controller for each gas to measure and control the quantity of each gas; optionally, at least one flow gauge to control the gas flow from the source to the mass flow controller entry point; and optionally, a temperature control unit to ensure thermal conditions are maintained. In one embodiment of the present invention, the components are coupled by tubing to plumb incoming gas(es) from supply source to mass flow control, to temperature control unit and eventually into the projection optics assembly.

In one example implementation, the entry port into the projection optics assembly is constructed such that laminar flow is maintained.

According to one feature of the present invention, the temperature control unit can maintain the gas(es) at 22.22+/−0.1 degree Celsius (C).

According to a further feature of the present invention, Nitrogen, Helium, and/or other non-absorptive gases can be used so that strong absorption of 157 nm radiation by atmospheric gases, such as oxygen, among others, does not occur.

In another embodiment, an index varying system can be used in a high resolution catadioptric optical reduction system.

The present invention provides a method for controlling the index of refraction between and among the optical components of a projection system or optical reduction system and their medium by altering that medium. The method includes the step of replacing the gas(es) in the projection system's beam path, within and outside of the laser and in particular in the projection optic.

In one example, the method further includes the step of sustaining the conditions within the projection system during operation to provide a nominal configuration, and hence optimal performance, for photolithography.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention. In the drawings:

FIG. 1 is a diagram of an index varying system according to an embodiment of the present invention.

FIG. 2 is a diagram of an index varying system according to an embodiment of the present invention.

FIG. 3 is a diagram of an index varying system according to an embodiment of the present invention.

FIG. 4 is a flowchart illustrating the index varying method, according to an embodiment of the present invention.

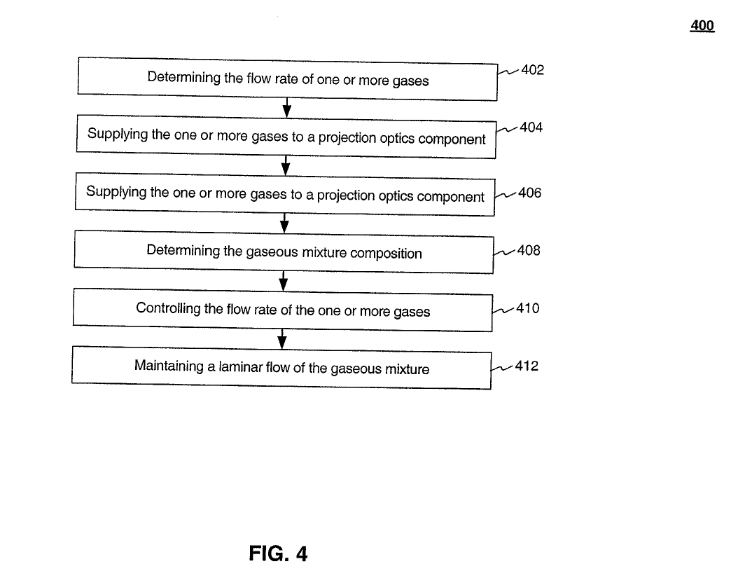

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

Terminology

To more clearly delineate the present invention, an effort is made throughout the specification to adhere to the following term definitions consistently.

The term “laminar flow” refers to non-turbulent flow of a fluid (liquid or gas) of constant viscosity (i.e., non velocity dependent).

The term “semiconductor” refers to a solid state substance that can be electrically and physically altered.

The term “semiconductor chip” refers to semiconductor device possessing any number of transistors or other components.

The term “semiconductor manufacturing tool” refers to equipment for possessing semiconductor chips or other elements.

The term “wafer” refers to the base material in semiconductor manufacturing, which goes through a series of process steps including photolithography, etching, deposition, ion implantation, and the like.

Index Varying System Embodiments

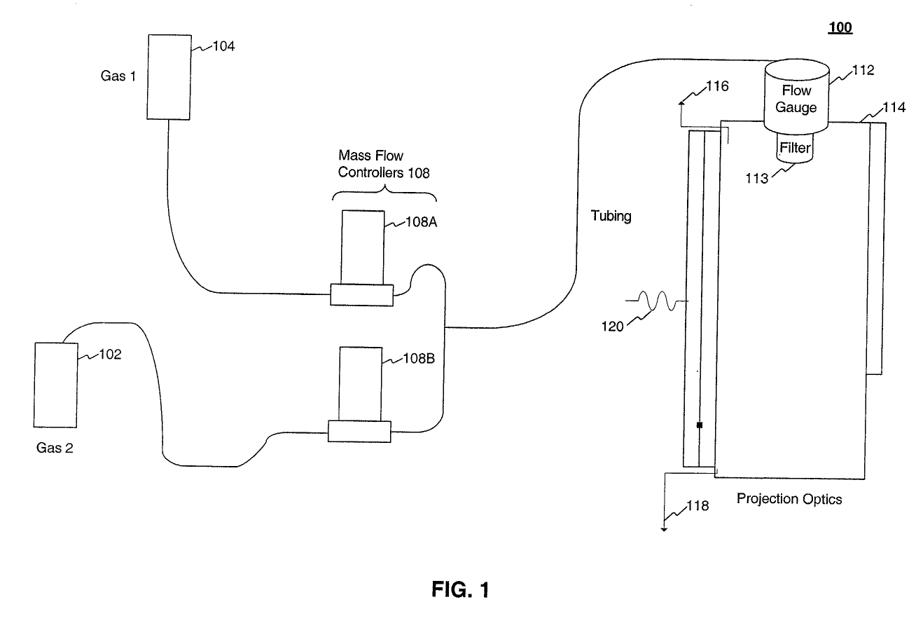

FIG. 1 is a diagram of an index varying system 100 for a semiconductor manufacturing tool according to one embodiment of the present invention. Index varying system 100 has a pair of gas supplies 102, 104, a mass flow controller 108 for each supply, a flow gauge 112, a filter arrangement 113, and projection optics 114.

Gas supplies 102, 104 can supply two different gases, G1 and G2, respectively. Mass flow controllers 108A, 108B measure and control the quantity of each supplied gas. Flow gauge 112 ensures laminar flow of the gas(es) into projection optics 114. Projection optics 114 houses one or more optical projection and/or reduction systems.

Gas overflow/pressure release valve 116 provides a controlled release of excess gas. In one embodiment, this excess gas is vented outside the system of the present invention. In another embodiment, the excess gas can be circulated and recycled for use in supplies 102 and 104.

Pressure leak 118, as shown, illustrates that the system can have some incidental leaks and still operate as described. The functionality of the present invention is dependent on maintaining the determined refractive level of the gas within the projection optics, while simultaneously ensuring that the gas does not interfere with the operation of the laser system (not shown) supplying the incident radiation (laser energy) 120.

In one embodiment, the valve 116 operates to minimize gas leaks 118 by maintaining a pressure level that is within system tolerances.

According to one embodiment of the present invention, G1 supply 104 can be used without G2 supply 102, or vice versa.

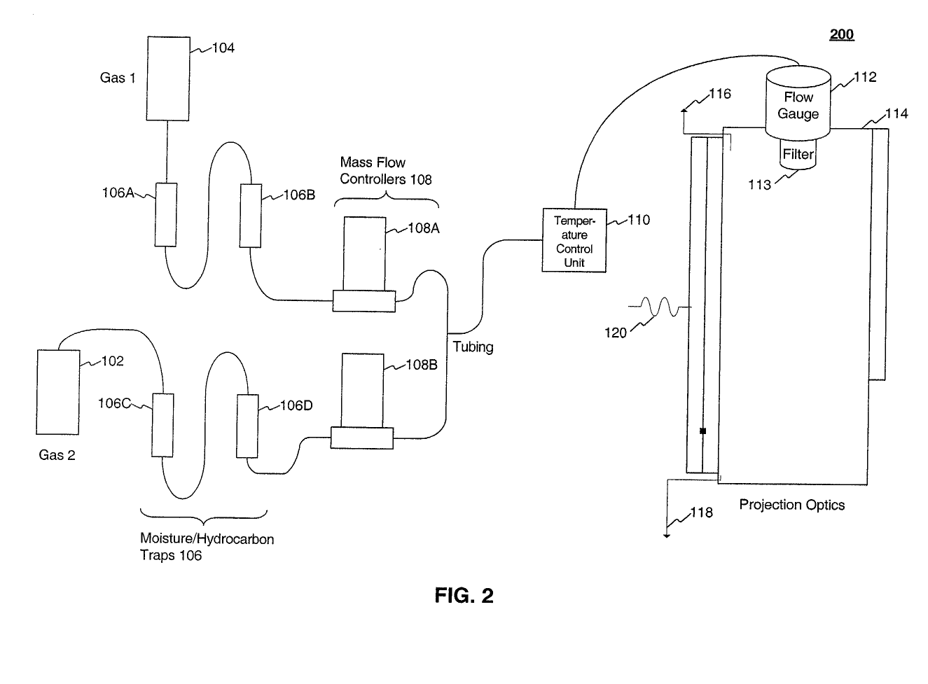

FIG. 2 is a diagram of an index varying system 200 for a semiconductor manufacturing tool according to another embodiment of the present invention. Index varying system 200 has a pair of gas supplies 102, 104, at least one filter (e.g., moisture/hydrocarbon trap) 106, a mass flow controller 108 for each supply, a temperature control unit 110, a flow gauge 112, a filter arrangement 113, and projection optics 114.

Gas supplies 102, 104 can supply gas 1 (G1) and gas 2 (G2), respectively. Filters 106A-D purify the incoming gases for contamination reduction purposes. Mass flow controllers 108A, 108B measure and control the quantity of each supplied gas. Temperature control unit 110 ensures that thermal specifications are maintained. Flow gauge 112 ensures laminar flow of the gas(es) into projection optics 114. The similarly labeled components from FIG. 1 provide the same functionality as described above. Projection optics 114 houses one or more optical projection and/or reduction systems, as would be apparent to a person skilled in the relevant art(s) based at least on the teachings described herein. See, for example, the projection optics disclosed in U.S. Pat. No. 5,537,260 entitled “Catadioptric Optical Reduction System with High Numerical Aperture” issued Jul. 16, 1996 to Williamson, which is incorporated by reference herein in its entirety.

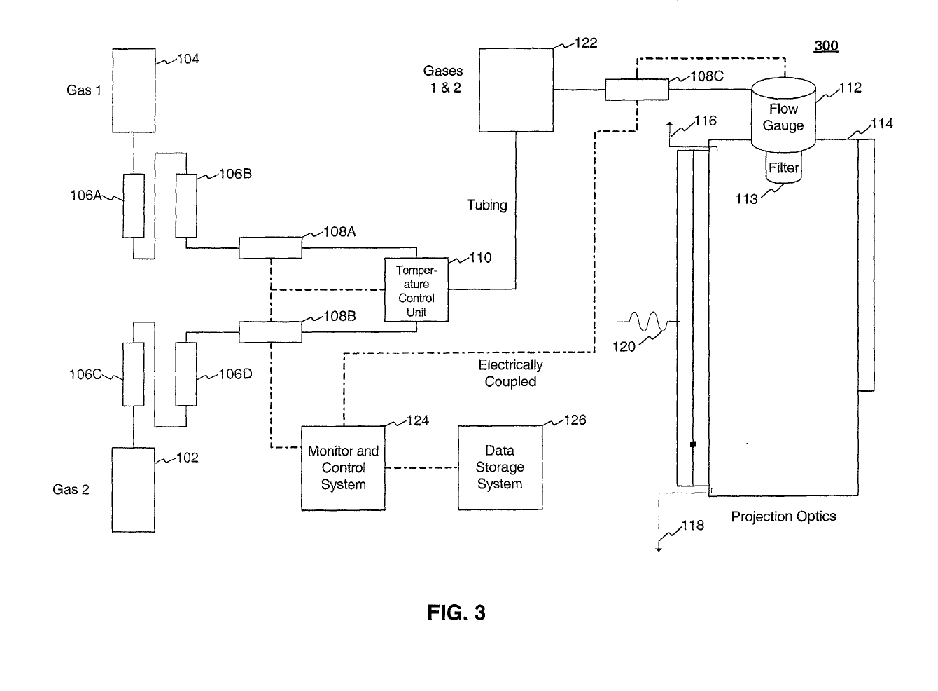

FIG. 3 is a diagram of an index varying system 300 for a semiconductor manufacturing tool according to still another embodiment of the present invention. Similar to system 200, index varying system 300 has a pair of gas supplies 102, 104, at least one filter (e.g., moisture/hydrocarbon trap) 106, a mass flow controller 108 for each supply, a temperature control unit 110, a gaseous mixture storage 122, a secondary mass flow controller 108C, a flow gauge 112, a filter arrangement 113, and projection optics 114.

The addition of gaseous mixture storage 122 after temperature control unit 110 provides a place for the heated gaseous mixture to expand and further mix. In one embodiment, the storage 122 is a pressure flexible storage component that expands to allow for variations in pressure without further increasing the temperature of the gaseous mixture. In another embodiment, the storage 122 maintains a sufficient pressure to maintain the temperature of the gaseous mixture.

Secondary mass flow controller 108C provides similar functionality as described herein with regard to the other mass flow controllers 108. The controller 108C controls the flow rate to the flow gauge 112.

In addition, system 300 illustrates one embodiment of the monitor and control systems regulating the gas composition and delivery rates into the projection optics component. The monitor and control system 124 is shown electrically coupled (i.e., coupled by any means which allows communication of the signals, electrical in nature, over a wired or wireless interface) to a data storage system 126. In addition, the system 124 is coupled to the mass flow controllers 108A-C, temperature control unit 110, and flow gauge 122.

The data storage system 126 contains records of the mass flow controller settings based on gas types, as well as temperature settings needed for the temperature control unit.

In the embodiment, pressure and temperature sensors can provide information to the monitor and control system 124 so that it can adjust the settings of one or more components electrically coupled to it. Other sensors can be employed, as would be apparent to a person skilled in the relevant art without departing from the spirit and scope of the present invention.

In the systems 100-300, tubing is shown as a plumbing means for the components of the systems. While the plumbing means are described in terms of this tubing, this is for convenience only and is not intended to limit the present invention. In fact, after reading the following description, it will be apparent to a person skilled in the relevant art(s) how to implement the following invention in alternative embodiments using alternative or equivalent plumbing means (e.g., plastic tubing, or by conjoining the components without tubing).

According to the present invention, the system 100, 200 corrects the optic aberrations due, but not limited to, altitude specific barometric pressure variations, temperature, and weather variations within a lithography apparatus. The system 100 includes at least one gas supply 104 to provide a gas for a mixture, at least one mass flow controller 108 associated with each gas supply, where the mass flow controller 108 measures and controls the quantity of a respective gas for the mixture, and at least one flow gauge 112 to substantially maintain laminar flow within the lithography apparatus.

According to an embodiment of the present invention, the system 200 can further include at least one filter 106 to purify each gas for each gas supply (e.g., a moisture/hydrocarbon trap). The system 200 can further include at least one temperature control unit 110 to maintain the temperature of the mixture at predetermined thermal specifications (e.g., at 22.22+/−0.1 degree Celsius (C)).

Index Varying Method Embodiments

The present invention also provides a method for reducing optical aberrations. The method includes the supplying gas(es) through mass flow controllers into a projection optics component to simulate various altitude conditions that are optimal for either the configuration of the projection optic system or operation of the system at wavelength equal to or less than 170 nm, for example at 157 nm. In one example, the method further includes the steps of regulating the gaseous flow with filters and maintaining the temperature of the gas(es) with a temperature control unit.

According to one embodiment of the present invention, a method for correcting optic aberrations due, but not limited to, altitude specific barometric pressure variations, temperature, and weather variations within a lithography apparatus includes steps to establish a flow of gases. These gases to be delivered to a lithography apparatus, such as projection optics 114. The system can control the flow of the gases, and to maintain a laminar flow into the lithography apparatus, such that the laminar flow is kept to a rate at which the gaseous mixture can be introduced without creating turbulence that caused other optical aberrations.

According to another embodiment of the present invention, the method also includes steps to filter the flow of gases to substantially maintain the purity of each gas, and to maintain the temperature of the gases.

According to embodiments of the present invention, the mass flow controllers are used to vary the ratios of the gases used to create the proper pre-determined index of refraction. Furthermore, as described below with respect to equations 1 and 2, the flow rates are direct ratios to the percentage of each gas needed to alter the index of refraction and simulate a given condition.

In another embodiment of the present invention, the lens alignment process can be performed under the above-stated conditions in a controlled environment (e.g., temperature controlled to 22.22+/−0.1 degree C).

According to the embodiments described herein, a computational operation can be performed to determine the proper gas mixture percentages as follows: (nG1ₐₗₜ−1)=Palt/Psl (nG1ₛₗ−1) (EQ. 1) to determine the index of refraction at an altitude where P is the associated barometric pressure at altitude and sea level locales and (nG1ₐₗₜ−1)=a(nG1ₛₗ−1)+b(nG2ₛₗ−1) (EQ. 2) to calculate the gas percentages, where alt denotes altitude, sl denotes sea level, G1 is the first gas and G2 the second gas comprising the mixture, and that the two gas percentages add up to total quantity 1: a+b=1 (EQ.3). Examples of the above equations are shown in notation form below:

$$\begin{matrix}( {n}_{{G1}_{alt}} - 1 ) = \frac{{P}_{alt}}{{P}_{sl}} ( {n}_{{G1}_{sl}} - 1 ) ; and & ( Example of EQ . 1 ) \\ ( {n}_{{G1}_{alt}} - 1 ) = a ( {n}_{{G1}_{sl}} - 1 ) + b ( {n}_{{G2}_{sl}} - 1 ) ; and & ( Example of EQ . 2 ) \\ a + b = 1. & ( Example of EQ . 3 )\end{matrix}$$

Substituting EQ. 3 into EQ. 2 yields:

((Pₐₗₜ/Pₛₗ)−1)/(((nG2ₛₗ−1)/(nG1ₛₗ−1))−1)=b

The index of refraction at sea level is needed for the two gases at the wavelength and altitude location of interest. Solving for b gives the percentage of G2 needed. The G1 percentage is thereby calculated using EQ.3.

Thus, the method and system of the present invention reduces the negative effects of barometric pressure, which has a pronounced effect on the value of the index of refraction of the gaseous medium that resided in the projection optics.

According to embodiments of the present invention, the angular propagation of light rays from the optical components to the medium is altered. The present day understanding of the properties of light teaches that the wavefront of the light is changed by the change in the index of refraction. When the wavefront is changed in this fashion, optical aberrations occur and can fluctuate.

According to an embodiment of the present invention, the removal of the environmentally induced index alterations by replacing the environment with the index used during lens manufacture can control these aberrations, reducing the aberrations and allow for more consistent performance of the projection optics at any location. For example, a system constructed and developed for use at a high altitude can be used at a location that is not a high altitude through the use of the method and system of the present invention, either or both during manufacture and operation.

### Alternative Embodiments

Other embodiments for an index varying system can be generated through the use of similar or equivalently functioning components and methods as would be apparent to a person skilled in the art(s) given this description.

In order to improve the performance in situations of higher NA and shorter wavelengths, different implementations of the method described herein can be used to further reduce the optical aberrations.

In one example implementation, additional gases can be added to further alter the chemistry of the gaseous mixture and thereby altering the operating medium within the projection optics.

### Conclusion

While specific embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. An index varying system for controlling the behavior of the projection optics of a lithographic printing tool, comprising:
one or more gaseous supplies to provide one or more gases to a projection optics component, wherein at least one of said one or more gaseous supplies includes at least one of said one or more gases;
one or more mass flow controllers coupled to said one or more gaseous supplies, wherein said one or more mass flow controllers adjust the flow rate of said one or more gases supplied by said one or more gaseous supplies;
a flow gauge having access to said projection optics component, said flow gauge having a first and second opening with said first opening coupled to said one or more mass flow controllers and said second opening being positioned with access to the inside of said projections optics component; and
a filter arrangement coupled to said second opening of said flow gauge to ensure laminar flow of said one or more gases into said projection optics component.

2. The system of claim 1, wherein Helium is one of said one or more gases.

3. The system of claim 1, wherein Nitrogen is one of said one or more gases.

4. The system of claim 1, further comprising:
a monitor and control system electrically coupled to said one or more mass flow controllers and said flow gauge, wherein said monitor and control system regulates the flow rates of said one or more gases through said one or more mass flow controllers and said flow gauge based on at least one performance requirement of said projection optics component.

5. The system of claim 4, further comprising:
a data storage system electrically coupled to said monitor and control system, said data storage system having said at least one performance requirement of said projection optics and at least one corresponding gaseous mixture level required for said at least one performance requirements.

6. The system of claim 1, further comprising:
one or more filters that collect impurities from said one or more gases, wherein said one or more traps are coupled to said one or more gaseous supplies prior to said one or more mass flow controllers.

7. The system of claim 6, wherein said one or more filters are one or more moisture/hydrocarbon traps.

8. The system of claim 1, further comprising:
at least one temperature control unit that alters the temperatures of said one or more gases according to a predetermined thermal specification within said projection optics component, wherein said temperature control unit is coupled to said one or more mass flow controllers prior to said flow gauge.

9. The system of claim 8, wherein said at least one temperature control unit is at least one heat exchanger.

10. The system of claim 8, wherein said temperature control unit is electrically coupled to said monitor and control system.

11. The system of claim 8, further comprising:
a storage tank coupled to said temperature control unit that stores said one or more gases prior to delivery to said flow gauge.

12. The system of claim 8, wherein said predetermined thermal specification is 22.22±0.01 degrees Celsius (C).

13. The system of claim 1, further comprising:
a secondary mass flow controller coupled to said first opening of said flow gauge, said secondary mass flow controller calibrated to regulate the flow rate of said one or more gases to said flow gauge.

14. An index varying system for controlling the behavior of the projection optics of a lithographic printing tool, comprising:
one or more means for supplying one or more gases to a projection optics component, wherein at least one of said one or more means for supplying includes at least one of said one or more gases;
one or more means for controlling mass flow of said one or more means for supplying, wherein said one or more means for controlling mass flow adjusts the flow rate of said one or more gases supplied by said one or more means for supplying;
means for gauging the flow of said one or more gases by accessing said projection optics component, said means for gauging the flow of said one or more gases having a first and second opening with said first opening coupled to said one or more means for controlling mass flow and said second opening being positioned with access to the inside of said projections optics component; and
means for filtering, wherein said means for filtering is coupled to said second opening of said means for gauging to ensure laminar flow of said one or more gases into said projection optics component.

15. The system of claim 14, wherein Helium is one of said one or more gases.

16. The system of claim 14, wherein Nitrogen is one of said one or more gases.

17. The system of claim 14, further comprising:
means for monitoring and controlling electrically coupled to said one or more means for controlling mass flow and said means for gauging, wherein said means for monitoring and controlling regulates the flow rates of said one or more gases through said one or more means for controlling mass flow said means for gauging based at least one performance requirement of said projection optics component.

18. The system of claim 14, further comprising:
means for storing data electrically coupled to said means for monitoring and controlling, said means for storing data having said at least one performance requirement of said projection optics component and at least one corresponding gaseous mixture level required for said at least one performance requirements.

19. The system of claim 14, further comprising:
one or more means for removing impurities from said one or more gases, wherein said one or more means for trapping are coupled to said one or more means for supplying prior to said one or more means for controlling mass flow.

20. The system of claim 19, wherein said one or more means for trapping are one or more moisture/hydrocarbon traps.

21. The system of claim 14, further comprising:
means for controlling temperature that alters the temperatures of said one or more gases according to a predetermined thermal specification within said projection optics component, wherein said means for controlling temperature is coupled to said one or more means for controlling mass flow prior to said means for gauging flow.

22. The system of claim 21, wherein said means for controlling temperature is at least one heat exchanger.

23. The system of claim 21, wherein said means for controlling temperature is electrically coupled to said means for monitoring and controlling.

24. The system of claim 21, further comprising:
means for storing coupled to said means for controlling temperature that stores said one or more gases prior to delivery to said means for gauging flow.

25. The system of claim 21, wherein said predetermined thermal specification is 22.22±0.01 degrees Celsius (C).

26. The system of claim 14, further comprising:
second means for controlling mass flow coupled to said first opening of said means for gauging flow, said second means for controlling mass flow calibrated to regulate the flow rate of said one or more gases to said means for gauging flow.

27. A method for varying the refractive index within the projection optics of a lithographic tool, comprising:
1) determining a flow rate for one or more gases;
2) supplying said one or more gases to a projection optics component by one or more mass flow controllers, wherein said one or more gases are supplied at a flow rate determined in step 1);
3) determining a gaseous mixture composition, wherein said one or more gases form said gaseous mixture composition once combined after said one or more mass flow controllers;
4) controlling said flow rate of said one or more gases according to said gaseous mixture composition as determined in step 3), wherein said flow rate is controlled by said one or more mass flow controllers; and
5) maintaining a laminar flow into said projection optics component, wherein said laminar flow is determined by the rate at which a gaseous mixture can be supplied by a flow gauge without creating turbulence.

28. The method of claim 27, wherein said gaseous mixture composition is determined by sensors within said one or more mass flow controllers.

29. The method of claim 27, wherein said gaseous mixture composition is determined by sensors within said flow gauge.

30. The method of claim 27, further comprising:
6) filtering said one or more gases to ensure the purity of each or said one or more gases, wherein step 6) occurs between steps 2) and 4).

31. The method of claim 27, further comprising:
7) maintaining a predetermined thermal specification of said gaseous mixture, wherein step 7) occurs between steps 4) and 5).
